(19) United States
(12) Patent Application Publication
(10) Pub. No.: US 2005/0247397 A1
(43) Pub. Date: Nov. 10, 2005

(54) Process for producing embossed products

(75) Inventors: Christopher Scott Kraus, Sunman, IN (US); Michael Gomer Stelljes JR., Mason, OH (US); George Vincent Wegele, Mason, OH (US); Nicholas Jerome Wilke II, Independence, KY (US); Joseph Clifford Noll, Cincinnati, OH (US); Matthew Alan Russell, Middletown, OH (US); Wayne Robert Fisher, Cincinnati, OH (US); David Mark Rasch, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/147,700

(22) Filed: Jun. 8, 2005

Related U.S. Application Data
(63) Continuation-in-part of application No. 10/950,706, filed on Sep. 27, 2004.
(63) Continuation-in-part of application No. 10/673,659, filed on Sep. 29, 2003.

(51) Int. Cl. B31F 1/12; B31F 1/07; B32B 31/00

(52) U.S. Cl. 156/209; 162/132; 162/117; 162/111

(57) ABSTRACT

A method for producing a multi-ply embossed product including the steps of: providing two or more plies of material to a lamination apparatus, each ply having a lamination surface; laminating one ply of the two or more plies of material to at least one other of the two or more plies of material to provide a laminated web having a first lamination pattern; directing the laminated web to a separate embossing apparatus; and embossing the laminated web in a second pattern to provide an embossed web, wherein the embossing step takes place after the laminated web is laminated.

### FIELD OF THE INVENTION

The present invention relates to an improved apparatus and process for producing embossed web products and more particularly to embossed laminated web products.

### BACKGROUND OF THE INVENTION

The embossing of webs, such as paper webs, is well known in the art. Embossing of webs can provide improvements to the web such as increased bulk, improved water holding capacity, improved aesthetics and other benefits. Both single ply and multiple ply (or multi-ply) webs are known in the art and can be embossed. Multi-ply paper webs are webs that include at least two plies superimposed in face-to-face relationship to form a laminate.

During the embossing process, the web is typically fed through a nip formed between juxtaposed generally axially parallel rolls. Embossing elements on the rolls compress and/or deform the web to provide embossments to the web. Different embossing processes are known, but typically either “knob-to-knob” embossing or “nested” embossing processes are implemented for flexible webs such as paper webs. Knob-to-knob embossing typically consists of generally axially parallel rolls juxtaposed to form a nip between the embossing elements on opposing rolls. Nested embossing typically consists of embossing elements of one roll meshed between the embossing elements of the other roll.

When multi-ply products are being formed, two or more plies are typically fed through the nip and regions of each ply are brought into a contacting relationship with the opposing ply. Often, the embossing process provides a means for laminating the plies of the web (i.e. maintaining the plies in a face-to-face contacting relationship).

While known laminating and embossing technologies have provided suitable multi-ply web products, the methods used to laminate and emboss webs, such as paper webs, may be inefficient or provide manufacturing difficulties if the manufacture of the web includes other converting steps such as, for example printing, calendaring, etc. In such cases, for example, the embossing step in the manufacture of the web can make it difficult to print on the embossed web or otherwise provide an additive to the web in a particular location and/or at an even add-on amount. Further, any manufacturing processes after the embossing step may reduce the effectiveness of the embossing step by, for example, reducing the height of the embossments or delaminating the web plies. Further yet, attempting to laminate the plies of a multi-ply web during an embossing step can reduce line speed potential, contaminate equipment and provide a web that has unintended lamination characteristics.

Accordingly, it would be desirable to provide an improved method for laminating and embossing a web. Further, it would be beneficial to provide an improved method for laminating and embossing a paper web, such as, for example a multi-ply web that includes at least one through-air-dried ply. It would also be desirable to provide a method for laminating a paper web and embossing the web where the lamination step and the embossing step are separate from each other. Further still, it would be desirable to provide a method for laminating a paper web, printing the paper web and embossing the paper web.

### SUMMARY OF THE INVENTION

In order to meet the shortcomings of the prior art, the present invention provides a method for producing a multi-ply embossed product including the steps of: providing two or more plies of material to a lamination apparatus, each ply having a lamination surface; laminating one ply of the two or more plies of material to at least one other of the two or more plies of material to provide a laminated web having a first lamination pattern; directing the laminated web to a separate embossing apparatus; and embossing the laminated web in a second pattern to provide an embossed web, wherein the embossing step takes place after the laminated web is laminated.

### BRIEF DESCRIPTION OF THE DRAWINGS

FIG. 1 is a schematic side view of one embodiment of a prior art method for laminating and embossing a web.

FIG. 2 is a schematic side view of one embodiment of the method of the present invention showing the laminating step separate from the embossing step.

FIG. 3 is a schematic side view of an alternative method of the present invention including a printing step.

FIG. 4 is an enlarged cross-sectional view of a deep-nested embossing apparatus.

FIG. 5 is an enlarged cross-sectional view of an embossed web.

### DETAILED DESCRIPTION OF THE INVENTION

It has been discovered that a new laminating and embossing method may provide improvements in embossing processes and the webs that are subjected to such embossing processes. In particular, it has been found that it may be advantageous to separate the lamination step and the embossing steps when embossing a multi-ply web product, such as a paper product. Such separation of the lamination and embossing steps is particularly preferred when the web is to be printed and or when the web includes at least one low density ply, such as, for example, a ply of through-air-dried paper.

As used herein, the term “through-air dried” or “TAD” when referring to a paper (or other) web means that the web has been subjected to a through-air-drying process where air is passed through the web to remove moisture from the web. Examples of TAD equipment, processes and structures formed by TAD processes are described in more detail in U.S. Pat. No. 3,301,746 issued Jan. 31, 1967 to Sanford et al.; U.S. Pat. No. 4,191,609 issued Mar. 4, 1980 to Trokhan; U.S. Pat. No. 4,637,859 issued Jan. 20, 1987 to Trokhan; and U.S. Pat. No. 5,607,551 issued Mar. 4, 1997 to Farrington Jr. et al.

TAD paper webs are often lower in density than conventional paper webs, are more porous and can be more extensible. These characteristics can make it more difficult to handle a web including at least one TAD ply and to perform certain manufacturing steps on such webs, including, but not limited to printing on the web, embossing the web and laminating the plies of the web if it is a multi-ply web.

As used herein, an “embossing apparatus” can be any apparatus used to emboss a web. Although much of the disclosure set forth herein refers to embossing apparatuses including rolls, it is to be understood that the information set forth is also applicable to any other type of embossing platform or mechanism that can be used to emboss the web such as cylinders, plates and the like. Examples of knob-to-knob embossing and nested embossing are illustrated in the prior art by U.S. Pat. No. 3,414,459 issued Dec. 3, 1968 to Wells; U.S. Pat. No. 3,547,723 issued Dec. 15, 1970 to Gresham; U.S. Pat. No. 3,556,907 issued Jan. 19, 1971 to Nystrand; U.S. Pat. No. 3,708,366 issued Jan. 2, 1973 to Donnelly; U.S. Pat. No. 3,738,905 issued Jun. 12, 1973 to Thomas; U.S. Pat. No. 3,867,225 issued Feb. 18, 1975 to Nystrand U.S. Pat. No. 4,483,728 issued Nov. 20, 1984 to Bauernfeind; U.S. Pat. No. 5,468,323 issued Nov. 21, 1995 to McNeil; U.S. Pat. No. 6,086,715 issued Jul. 11, 2000 to McNeil; U.S. Pat. No. 6,277,466 B1 issued Aug. 21, 2001 to McNeil; U.S. Pat. No. 6,395,133 issued May 28, 2002 to McNeil and U.S. Pat. No. 6,846,172 B2 issued Jan. 25, 2005 to Vaughn et al.

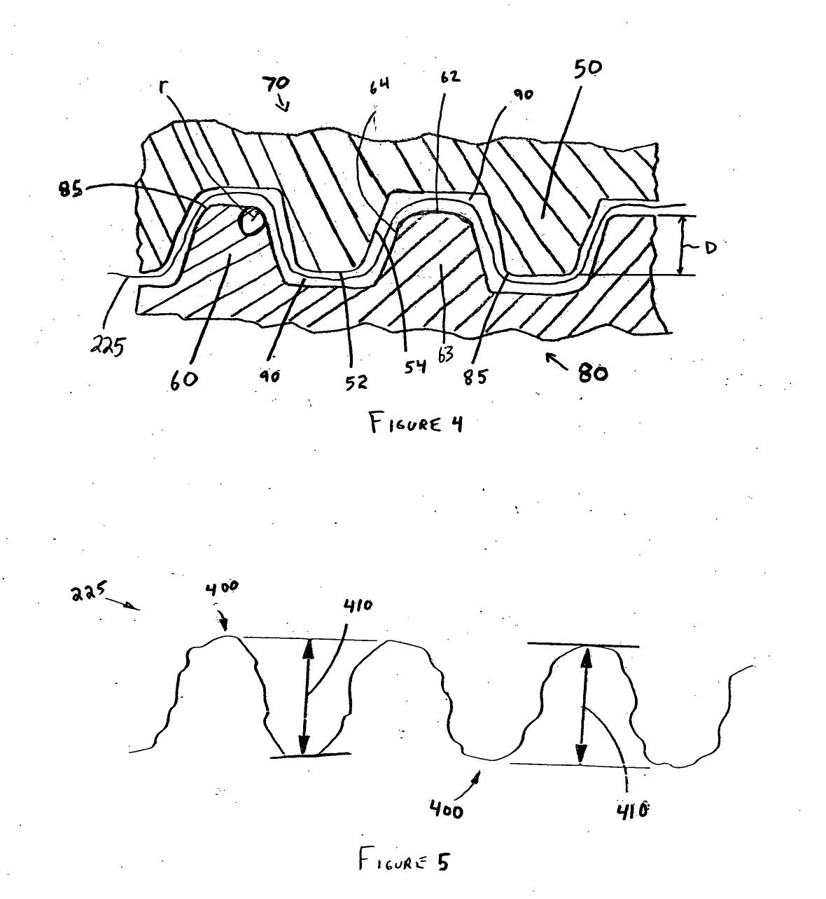

As used herein, the term “deep-nested embossing” refers to a type of nested embossing wherein the embossing members intermesh with each other, for example like the teeth of gears. Thus, the resulting web is deeply embossed and nested and includes plurality of undulations that add bulk and caliper to the web. In the deep-nested embossing process, the embossing elements of the embossing members generally engage each other to a depth D (as shown in FIG. 4) greater than about 0.5 mm, greater than about 1.0 mm, greater than about 1.25 mm, greater than about 1.5 mm, greater than about 2.0 mm, greater than about 3.0 mm, greater than about 4.0 mm, greater than about 5.0 mm, between about 0.5 mm and about 5.0 mm or any number within this range. Exemplary Deep-nested embossing techniques are described in U.S. Pat. No. 5,686,168 issued to Laurent et al. on Nov. 11, 1997; U.S. Pat. No. 5,294,475 issued to McNeil on Mar. 15, 1994; U.S. patent application Ser. No. 11/059,986; U.S. patent application Ser. No. 10/700,131 and U.S. Patent Provisional Application Ser. No. 60/573,727.

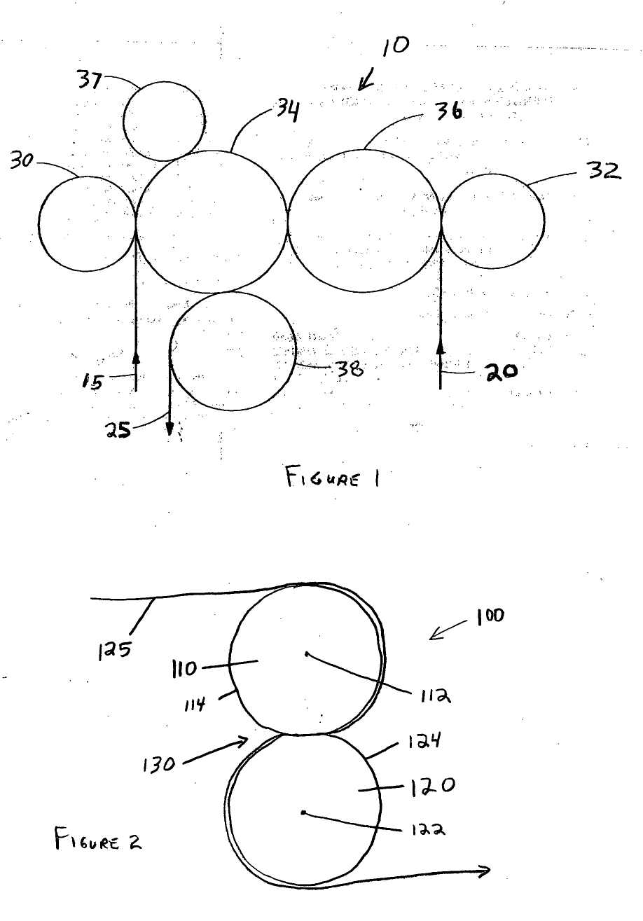

FIG. 1 is a depiction of one prior art method for embossing and laminating a two-ply web of paper in one process module. In the embossing and laminating module 10 shown, a first ply 15 and second ply 20 are embossed between mated pressure rolls 30 and 32 and likewise mated pattern rolls 34 and 36. The pressure rolls 30 and 32 and pattern rolls 34 and 36 are juxtaposed with generally parallel axes to form three nips, a first nip between the first pressure roll 30 and the first pattern roll 34, a second nip between the second pressure roll 32 and the second pattern roll 36 and a third nip between the first and second pattern rolls 34 and 36.

Pattern rolls 34 and 36 have knobs that extend radially outwardly and contact the periphery of the respective pressure rolls 30 or 32 at the respective nips to emboss the plies. Each ply 15 or 20 to be joined into the resulting multi-ply fibrous structure 25 is fed through one of the nips between the pattern rolls 34 or 36 and the respective pressure roll 30 or 32. Each ply 15 or 20 is embossed in the nip by the knobs of the pattern roll 34 or 36.

After embossing, one of the plies 15 or 20 may have adhesive applied by an adhesive applicator, such as applicator roll 37. The plies 15 and 20 are then joined together by passing them through a nip, such as the nip between the pattern rolls 34 and 36, a nip between one of the pattern roll 34 or 36 and a marrying roll, such as roll 38 or by passing the plies through any other nip or apparatus for pressing the plies 15 and 20 together such that the adhesive can join the plies 15 and 20. Typically, in such embodiments, it is important to have the joining material such as the adhesive present in the embossed regions since the embossed regions are the regions of the plies that are typically directed to be in contact with each other. Often registration problems occur between the adhesive and the embossed regions. This can reduce the effectiveness of the lamination, reduce the line reliability, require more adhesive than is actually necessary to hold the plies together and require complicated registration equipment to help ensure that the embossments are aligned with the adhesive.

In other prior art embodiments, high pressure bonding has been used where the plies 15 and 20 are bonded by pressing the plies between the knobs of pattern rolls 34 and 36. In such cases, the fibers are basically reduced to plastic and the resulting bond sites exhibit a glassine appearance. Bonding via high pressure is disclosed, for example, in U.S. Pat. No. 3,323,983 issued Sep. 8, 1964 to Palmer.

In these prior art methods, the bonding of the plies takes place during the embossing step or shortly after the embossing step in the same unit operation or process module. This can limit the overall bonding pattern between the web plies and can add significant complexity to the web making process. Further, in such embodiments, the benefits of the embossing (e.g. embossment height, bulk, caliper and aesthetic quality of the embossments) can be reduced as the plies are combined under pressure. Further still, if a printing step is involved in the manufacture of the end product and it is located downstream of the embossing module it may cause difficulties with printing on the web due to the embossments or a flattening of the web as it proceeds through the printing process.

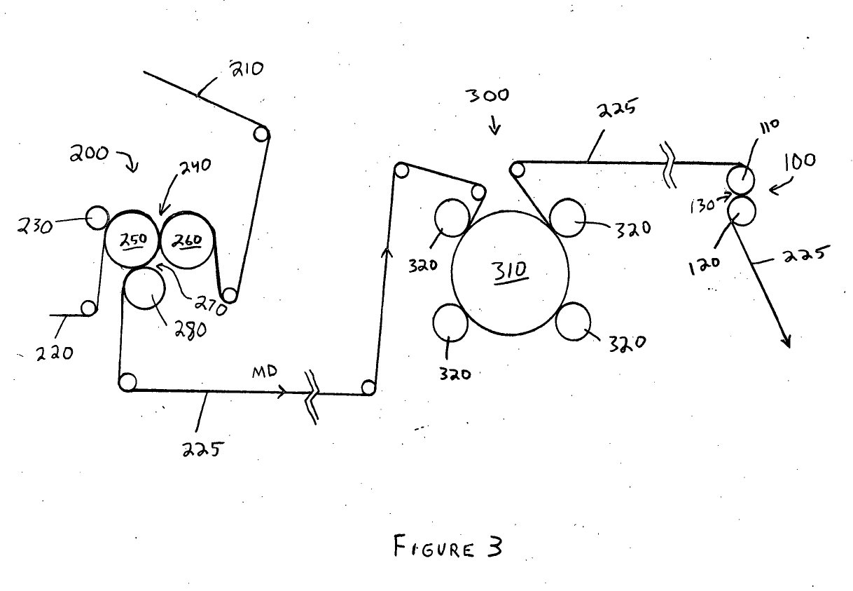

FIG. 2 shows one embodiment of the apparatus 100 of the present invention. The apparatus 100 includes a pair of rolls, first embossing roll 110 and second embossing roll 120. (It should be noted that the embodiments shown in the figures are just exemplary embodiments and other embodiments are certainly contemplated. For example, the apparatus 100 could be configured such that the web 125 does not s-wrap the rolls 110 and 120, but rather passes straight between them. Further, the embossing rolls 110 and 120 of the embodiment shown in FIG. 2 could be replaced with any other embossing members such as, for example, plates, cylinders or other equipment suitable for embossing webs. Further yet, additional equipment and steps that are not specifically described herein may be added to the apparatus and/or process of the present invention.) The embossing rolls 110 and 120 are disposed adjacent each other to provide a nip 130. The rolls 110 and 120 are generally configured so as to be rotatable on an axis, the axes 112 and 122, respectively, of the rolls 110 and 120 are typically generally parallel to one another. The apparatus 100 may be contained within a typical embossing device housing. Each roll has an outer surface 114 and 124, respectively, comprising a plurality of protrusions or embossing elements extending therefrom. The embossing rolls 110 and 120, including the surfaces of the rolls 114 and 124 as well as the embossing elements, may be of any suitable size and may be made out of any material suitable for the desired embossing process. Such materials include, without limitation, steel and other metals, ebonite, and hard rubber or a combination thereof.

As shown in FIG. 2, the first and second embossing rolls 110 and 120 provide a nip 130 through which the web 125 is passed. In the embodiment shown, the web 125 is a multi-ply web made up of at least two plies that have been previously joined together to provide the resulting web 125. The resulting web 125 is embossed as it passes through the nip 130 between first and second embossing rolls 110 and 120. As can be seen, the embossing step shown in FIG. 2 is relatively simple compared to the prior art embossing processes. This simple embossing step and apparatus can be used in conjunction with other process steps performed on the same manufacturing line or can be implemented completely separately from other processing steps. Thus, the limiting effects of typical combined embossing and laminating equipment and methods can be reduced or even eliminated.

As shown in FIG. 2, the web 125 is wrapped around the rolls 110 and 120 of the apparatus 100 in an “s-wrap” configuration. (As used herein, the term “s-wrap” refers to a configuration where a web is wrapped around two adjacent rolls such that the web is disposed against the surface of the upstream roll (the first roll in the device that a particular portion of the web encounters as it moves in the machine direction) for at least about 45 degrees prior to passing through the nip between the rolls and remains disposed against the surface of the downstream roll for at least about 45 degrees after it passes through the nip.) In the particular configuration shown in FIG. 2, the web 125 is disposed against the surface 114 of the first roll 110 for about 180 degrees prior to passing through the nip 130 and is disposed against the surface 124 of the second roll 120 for about 180 degrees after passing through the nip 130. However, other configurations are possible, such as, for example where the web 125 is disposed against the surface 114 of the first embossing roll 110 and/or the surface 124 of the second embossing roll 120 for less than 180 degrees. Further, embodiments are contemplated wherein the web 125 is wrapped around a portion of the surface of one of the embossing rolls 110 or 120 to a greater extent than the other of the embossing rolls or wherein the web 125 is wrapped around a portion of the surface of only one of the embossing rolls 110 or 120.

It has been found to be advantageous to s-wrap the web 125 about the embossing apparatus 100 verses merely passing the web through the nip 130 between the embossing rolls 110 and 120. Specifically, s-wrapping the web 125 gives more positive control of the web 125 through the nip 130. This can help reduce web slippage in the nip 130 as well as cross-direction web control. Some of the advantages that can come from s-wrapping the web 125 verses passing it straight through the nip 130 include, but are not limited to better embossing efficiency (i.e. embossing elements with lower heights can provide similar embossing characteristics as higher embossing elements in a straight through configuration), better embossed appearance on the web 125, higher wet burst strength, fewer defects in the web caused by the embossing process and better alignment of the print colors to each other if multiple print colors are used.

FIG. 3 is an example of how the embossing apparatus 100 of the present invention may be incorporated into a more complex converting operation while maintaining the benefits of its separation from the lamination, printing steps and/or other apparatus or operations. As shown, the embossing apparatus 100 and method of the present invention can be integrated into a multi-operation manufacturing or converting process. However, it is also contemplated that the embossing apparatus 100 and method of the present invention may be a completely separate, stand alone unit operation. In either case, the separation of the embossing apparatus 100 and method from the lamination apparatus and method provides for simplicity and flexibility in the manufacturing and converting of the web.

As noted above, FIG. 3 shows how the embossing apparatus 100 of the present invention can be configured to operate on the same manufacturing or converting line as other desired equipment. For example, as shown in FIG. 3, the embossing apparatus 100 is shown to be downstream of (or following) two other exemplary converting operations. (As used herein, the term “downstream” refers to any process or operation that is located after, in time, the process or operation to which it is being compared. The process or operation steps being compared need not be part of an integrated unit or a single manufacturing line, but rather can be distinct and separate operations that have no physical connection to each other. Further, the operations being compared may be located together in the same facility or may be located in separate facilities or separate places within a particular facility.)

In the unit operation shown on the left of FIG. 3, a laminating apparatus 200 joins two single ply webs, webs 210 and 220 into a single multi-ply web 225. In this case, the laminating apparatus 200 includes an adhesive applicator roll 230 that provides adhesive to one of the plies 220 of the web 225. However, the adhesive applied to the web may be provided by any known means including spraying, flexographic printing, gravure printing, patterned roll application and the like. Further, any other means for joining the plies can be used, including, for example, mechanical bonding of the plies or any other known method of providing a ply bond. In the embodiment shown, the individual web plies 210 and 220 are brought in contact with each other at the nip 240 between the rolls 250 and 260. The rolls 250 and 260 can be any suitable type of roll and made from any suitable material. In certain embodiments the rolls 250 and 260 may be made from steel or other hard materials and one or both of the rolls may include a coating, such as a rubber or synthetic rubber coating.

In one embodiment, at least one of the rolls 230, 250 or 260 is a patterned roll with a pattern disposed on the surface of the roll. The patterned rolls may be of any type known in the art and specifically, for example, may include any of the pattern rolls described in the patents identified above relative to the knob-to-knob and nested embossing rolls. The pattern on the roll(s) allows the adhesive used to join the web plies to be provided in a particular pattern onto the web. The pattern of adhesive may be any desired pattern and may be continuous, discontinuous or semi-continuous. An example of a continuous pattern of adhesive would be a pattern of lines that are all interconnected such that one can follow the pattern from any point on the pattern to any other point on the pattern without having to cross a gap in the pattern. An example of a discontinuous pattern would be a pattern of discrete areas of adhesive such as spots, dashes or other unconnected shapes. A semi-continuous pattern would include a pattern wherein the pattern elements making up the pattern are continuous in at least one direction (e.g. the cross-machine direction), but are not interconnected with all of the other pattern elements directly or indirectly. Thus, one could not get from any point on the pattern to any other point on the pattern without having to cross a gap in the pattern.

Patterned adhesive is often desirable to reduce the amount of adhesive used verses coating the entire ply of the web 220 with adhesive. In typical paper applications, the surface area coverage of the adhesive (or other ply bonding material) is generally less than about 50% of the surface of the web ply to which it is applied, but can be any percentage such as, for example, less than about 30%, less than about 25%, less than about 15%, less than about 10%, between about 5% and 50%, between about 5% and about 25%, between about 5% and about 15% or any range or particular percentage between about 5% and about 50%. If more than one of the plies of a two-ply product has an adhesive or other ply bonding material applied thereto, the above noted percentages of surface are coverage would typically be in reference to the maximum total percentage of the surface area that the adhesive or other bonding material covers on either ply of the two plies after the plies are combined. However, in certain embodiments, a pattern of adhesive is not used, but rather, the entire surface of the web 220 has adhesive applied thereto.

In the particular embodiment shown in FIG. 3, the plies 210 and 220, now in face-to-face contact, are directed through nip 270 that is between roll 250 and marrying roll 280. (As used herein, the term “face-to-face” refers to an orientation of webs wherein one of the generally planar surfaces of one ply is disposed adjacent to one of the generally planar surfaces of the ply with which it is in a face-to-face orientation. Often, as in the particular example described herein, where a pattern of adhesive is used to combine the plies 210 and 220 and/or when a pattern roll is used to bring the plies 210 and 220 of the web together in a face-to-face configuration, only a portion of the surface of each ply 210 and 220 will be actually contacting the other ply and/or bonded to the other ply.) Of course, this is just one of any number of lamination methods and apparatuses that can be used to join the plies of material and the example should not be considered limiting in any way to the scope of the present invention. The combined web 225 then leaves the laminating apparatus 200 and progresses downstream in the machine direction MD toward the next unit operation.

In the exemplary embodiment of FIG. 3, the combined web 225 is shown to leave the lamination apparatus 200 and be directed to a printing apparatus 300. However, it should be noted that the particular operation following the lamination operation need not be a printing operation and the method of the present invention need not include a printing step at all. In fact, the order of the printing operation and the lamination operation could be reversed, if desired. Further, any other desirable manufacturing or converting operation can be included between the different operations shown in FIG. 3. Further, the operations can be completely separate from each other (i.e. not part of a single manufacturing or converting line) or may be part of a continuous process.

The printing apparatus 300 of FIG. 3 is shown to include a central impression cylinder 310 and printing plate cylinders 320. As shown, the web 225 is directed into the printing apparatus 300 where one or more substances are added to the web 225 as the web passes between the impression cylinder 310 and the printing plate cylinders 320. Typically, the substance added during this operation is an ink or other material to add color to the web 225, or at least portions of the web. However, other substances can be added by the printing apparatus 300 instead of inks, etc or in addition to the ink or other color additives. In the particular embodiment shown, four different colors are added, one at each of the printing plate cylinders 320. As the number of colors or other additives increases, typically, the complexity of the printing process will increase. This is generally due to the fact that it is often desirable to align the different colors in a particular way so as to create a particular image or aesthetic feature. One advantage to the system of the present invention, as shown in FIG. 3, is that the embossing step is downstream of the printing step. Thus, printing on the web 225 is much less difficult and is more predictable, which can be an advantage for many reasons including when it is desirable to register the printing to the embossing pattern or to register printing colors to each other.

One reason for this complexity is that with an embossed web, the embossments can make it difficult to print on the web in the particular location desired due to the varied topography of the web. Additionally, the printing apparatus 300 may temporarily or permanently reduce the height of or flatten out the embossments to at least some extent while the web is in the printing apparatus 300 which can make alignment of various colors extremely difficult and can reduce the advantages that the embossments may provide the resulting web 225. Further, with extensible webs such as typical TAD paper webs, printing, and especially registered printing, can be difficult due to the flexibility and extensibility of the web, the low density of the web and small holes in the web. The difficulty can be exaggerated by embossing such webs prior to printing on them.

In the printing step shown in FIG. 3, the web 225 is directed into the printing apparatus 300 while it is in a relatively planar configuration without embossments. Thus, alignment of the various printing colors can be achieved. Further, as noted above, because the embossing of the web is after the printing process, the printing apparatus will not affect or will at least have a significantly reduced affect on the embossments in the final web 225.

The final operation shown in FIG. 3 is the embossing operation performed by the embossing apparatus 100 of the present invention. As described above with regard to other manufacturing and/or converting operations, the embossing operation can be an integral part of the same manufacturing or converting line that includes the lamination and/or printing operations (or any other desired operations) or may be a completely separate apparatus that can be located in the same facility as one or more of the other operations, in a different part of the same facility or in a different facility all together. Thus, the web 225 can be fed directly into the embossing apparatus 100 from another unit operation or may be fed into the embossing apparatus 100 from a roll or another storage apparatus.

In the embodiment shown, the embossing apparatus 100 includes embossing rolls 110 and 120 that provide nip 130 through which the web 225 is directed. In the nip 130, the web is embossed by protrusions that extend outwardly from the surface of at least one of the embossing rolls 110 and 120. However, as noted herein, the embossing apparatus 100 can include any suitable apparatus for embossing the web 225. For example, the embossing apparatus 100 may include plates (one example of which is shown in FIG. 4) in place of the embossing rolls 110 and 120. Further, the embossing apparatus may include or be configured to interact with other devices such as equipment for producing moisture and directing it toward the web 225 or embossing apparatus 100, equipment for providing heat to the web 225 and or embossing apparatus 100 or equipment for providing steam to the web 225 and or embossing apparatus 100. After the embossing step, the web 225 can be directed to any other desired manufacturing or converting operation, including an apparatus for winding the web 225.

One of the primary advantages to the method of the present invention is that because the embossing apparatus 100 is separated from the lamination apparatus 200, the structure of the embossing apparatus 100 is not limited by the structure of the lamination apparatus 200. Thus, the embossing apparatus 100 may include embossing rolls 110 and 120 made out of any suitable material for embossing the web without the need to be compatible with other rolls with which they would have to interact in a combination lamination/embossing unit. Further, the embossing rolls 110 and 120 can be sized (e.g. diameter or length) to best meet the needs of the embossing operation without regard to the lamination operation. Thus, for example, the rolls may be smaller in diameter than they would be if they were employed in certain typical combination lamination/embossing unit. This is because in certain typical lamination/embossing units, the rolls used to laminate the web and emboss the web may include one hard roll, such as a steel roll with embossing elements on its surface that is pressed against a rubber roll or a roll coated with a flexible material. In such cases, in order to get good quality embossments in the web, the pressure along the rolls in the nip can be very great. For example, in a setup where a steel pattern roll is pressed against a roll with a rubber cover, the pressure in the nip can be as much as about 10 kilonewtons per meter and in some cases up to about 30 kilonewtons per meter or more. Thus, in order to maintain tight tolerances along the length of the rolls, they generally need to be rather large in diameter, such as, for example greater than 30 cm or more. In a separated lamination/embossing process, the rolls can be much smaller in diameter because the rolls need not withstand the nip pressures of the combined unit. Rather, the pressures in a nip of an embossing unit that is not part of a combination lamination/embossing unit can be as low as or less than about 5 kilonewtons per meter, about 2.5 kilonewtons per meter, about 1.5 kilonewtons per meter or even less. Accordingly, rolls of much smaller diameter can be used and maintain the same or better tolerances than the large rolls of the combined unit. For example, rolls having a diameter of about 15 cm to about 20 cm have been found to be suitable for the apparatus and method of the present invention. Not only does the diameter difference reduce the cost of the rolls themselves, the equipment needed to support the rolls and the space in which the rolls are located, it reduces the area that needs to be engraved or otherwise modified to provide the embossing elements. Thus, significant cost savings can be achieved by separating the lamination apparatus and process from the embossing apparatus and process.

Further, because the lamination and embossing steps are separated, the embossing rolls 110 and 120 can be provided so as to emboss webs 225 that have been cut down in size (e.g. in the cross-machine direction). This can allow for different embossing patterns for different parts of the same laminated web. Also, due to the separation of the lamination and the embossing steps, a single converting line can easily be configured to produce different products. For example, different sets of embossing members, such as embossing rolls 110 and 120, can be provided on a single converting line and can be engaged or disengaged depending on the particular product that is to be produced. This flexibility is not generally available for converting lines wherein the lamination and the embossing take place in a single unit operation.

Yet another significant advantage to separating the embossing operation from the lamination operation is the ability to provide the multi-ply web 225 with better ply bonding characteristics. For example, in a combination lamination/embossing unit, the bonding of the web plies 210 and 220 and the embossing of the plies happens almost instantaneously. Thus, the adhesive used to bond the plies 210 and 220 may not have much time to set up and provide bond strength between the time it is applied to one or more of the plies 210 and 220 and the time the combined plies 210 and 220 are embossed and/or married to join them together. For example, in a typical combination lamination/embossing unit running at commercial line speeds, the time between when the glue is applied to one or more of the plies 210 and/or 220 and when the plies 210 and 220 are combined may be less than about 0.1 seconds. Typical adhesives used for ply bonding may not be able to set up in this short of a period of time and may allow for some slippage between the plies 210 and 220 as the plies 210 and 220 are being embossed and/or married together. Thus, it is an advantage to be able to separate the lamination step from the embossing step in the web manufacturing process. The present invention provides the ability to separate the lamination and embossing operations and thus, can provide for better ply bonding and/or more flexibility in the materials used to bond the plies 210 and 220.

For example, in typical embossing and lamination units, if an adhesive is used, the adhesive will typically be a solution of water or another solvent and solids. The solids are generally the part of the adhesive that actually provides the adhesion properties once the solvent is typically removed, for example, by evaporation. Thus, the amount or percentage of solids in the adhesive can affect the strength of the ply bonds. In general a higher percentage of solids will provide stronger and more reliable ply bonding. In typical papermaking situations, however, an embossing and laminating station will often employ an adhesive that has from about 2% to about 5% solids. These percentages are relatively low percentage of solids from an adhesive standpoint. However, such low percentages are often needed to allow the adhesive to flow as necessary through the equipment. A problem associated with low percentages of solids is that the adhesive can take a longer time to set than one with a higher percentage of solids. Thus, in a combination lamination/embossing unit, the adhesive may not have time to set while the web is still moving through the piece of equipment. Thus, the ply bonding can be weakened or the bonding sites can end up being in locations not aligned with the embossments, which is often preferred in such configurations. Further, as an adhesive increases in solids, it generally becomes more viscous. This can present process hygiene problems that can reduce line reliability and can affect the quality of the end product. Thus, with a combination lamination and embossing unit, there are problems with the ply bonding that can not easily be overcome.

When the lamination process is separated from the embossing operation, such problems can be reduced or eliminated. One way to ensure better ply bonding is to separate the embossing unit from the lamination unit in time such that the adhesive has enough time to set up prior to the embossing step. Also, however, the separation of the lamination from the embossing allows the use of adhesive mixtures with higher solids concentrates, such as for example greater than about 5%, greater than about 6%, greater than about 7%, greater than about 8%, greater than about 9% or greater than about 10% solids. (As used herein, the percentages of solids in the adhesive solution are percentages measured by weight.) This is often due to the fact that the more viscous adhesive will not present the hygiene problems that are presented when the laminating equipment and the embossing equipment are interactive with each other. For example, one of the hygiene problems that can be problematic is the build up of adhesive on the knobs or embossing elements of one of the pattern rolls. This problem can get worse with more viscous adhesives. However, if the adhesive has time to set up, as in a configuration wherein the laminator and embossing apparatus are separated, the likelihood of adhesive build up on the pattern rolls(s) is greatly reduced. Another advantage of using adhesives with higher solid contents is that less glue can be used to provide the intended ply bond strength.

The apparatus and method of the present invention allow the lamination step and the embossing step to be separated to any desired extent. Thus, for example, the lamination step and the embossing step can be separated such that at commercial line speeds (e.g. greater than about 500 to about 700 meters per minute), lamination occurs at least about 0.25 seconds prior to embossing, at least about 0.5 seconds prior to embossing, at least about 1.0 second prior to embossing or greater. In fact, due to the fact that the embossing apparatus 100 can be located anywhere on the manufacturing line, the optimum location for the apparatus 100 can be determined based on the web material being manufactured and/or the material being used to bond the web plies. Further, as noted above, the embossing apparatus 100 could be completely removed from the rest of the web manufacturing or converting process. Thus, the time between the lamination of the plies 210 and 220 of the web 225 and the embossing operation could be several seconds, minutes, hours, days, weeks or even longer.

In certain embodiments, as shown, for example, in FIG. 4, the web 225 may be deeply embossed by a deep-nested embossing apparatus and method. In such deep-nested embossing processes, the embossing elements 50 and 60 of the embossing plates 70 and 80 engage each other to a depth D greater than about 0.5 mm, greater than about 1.0 mm, greater than about 1.25 mm, greater than about 1.5 mm, greater than about 2.0 mm, greater than about 3.0 mm, greater than about 4.0 mm, greater than about 5.0 mm, between about 0.5 mm and about 5.0 mm or any number within this range. In the embodiment shown, the embossing elements 50 and 60 engage each other as described above, but do not touch each other or the regions between the engaging elements of the opposite member. This provides a space 90 in which the web 225 resides while it is being embossed. In certain embodiments, portions of the embossing elements 50 and 60 can touch each other when the embossing apparatus is fully engaged or may extend all of the way to the regions between the embossing elements on the opposing embossing member. (Of course, in the actual embossing process, the embossing members generally do not touch each other or the opposing embossing member because the web is disposed between the embossing members.) Although FIG. 4 shows an example of two intermeshing embossing plates, embossing plate 70 and embossing plate 80, the information set forth herein With respect to the embossing elements 50 and 60 is applicable to any type of embossing platform or mechanism from which the embossing elements 50 and 60 can extend, such as rolls, cylinders, plates and the like.

The resulting embossed web 100 can have embossments of any shape, pattern, density and height. One advantage of the present invention is that it provides a method that is suitable for providing the web 100 with embossments with relatively high embossment heights, as compared to typical embossed webs. Accordingly, the apparatus and method of the present invention can provide embossments of any height, including, but not limited to webs with an average embossment height of at least about 650 μm. Other embodiments may have embossment having embossment heights greater than 1000 μm, greater than about 1250 μm, greater than about 1450 μm, at least about 1550 μm, at least about 1800 μm, between about 650 μm and about 1800 μm, at least about 2000 μm, at least about 3000 μm, at least about 4000 μm, between about 650 μm and about 4000 μm or any individual number within this range. The average embossment height is measured by the Embossment Height Test Method using a GFM MikroCAD optical profiler instrument, as described in the Test Method section below.

In certain embodiments, as shown, for example, in FIG. 4, at least some of the first embossing elements 50 and/or the second embossing elements 60, may have at least one transition region 85 that has a radius of curvature r. The transition region 85 is disposed between the distal end of the embossing element and the sidewall of the embossing element. (As can be seen in FIG. 4, the distal end of the first embossing element 50 is labeled 52, while the sidewall of the first embossing element 50 is labeled 54. Similarly, the distal end of the second embossing element 60 is labeled 62, while the sidewall of the second embossing element 60 is labeled 64.) The radius of curvature r is typically greater than about 0.075 mm. Other embodiments have radii of curvatures greater than 0.1 mm, greater than 0.25 mm, greater than about 0.5 mm, between about 0.075 mm and about 0.5 mm or any number within this range. The radius of curvature r of any particular transition regions is typically less than about 1.8 mm. Other embodiments may have embossing elements with transition regions 130 have radii of curvatures less than about 1.5 mm, less than about 1.0 mm, between about 1.0 mm and about 1.8 mm or any number within the range. (Although FIG. 4 shows an example of two intermeshing embossing plates, embossing plate 70 and embossing plate 80, the information set forth herein with respect to the embossing elements 50 and 60 is applicable to any type of embossing platform or mechanism from which the embossing elements can extend, such as rolls, cylinders, plates and the like.)

The “rounding” of the transition region 85 typically results in a circular arc rounded transition region 85 from which a radius of curvature is easily determined as a traditional radius of the arc. The present invention, however, also contemplates transition region configurations which approximate an arc rounding by having the edge of the transition region 85 removed by one or more straight line or irregular cut lines. In such cases, the radius of curvature r is determined by measuring the radius of curvature of a circular arc that has a portion which approximates the curve of the transition region 85.

In other embodiments, at least a portion of the distal end of one or more of the embossing elements other than the transition regions 85 can be generally non-planar, including for example, generally curved. Thus, the entire surface of the embossing element spanning between the sidewalls 54 or 64 can be non-planar, for example curved. The non-planar surface can take on any shape, including, but not limited to smooth curves or curves, as described above, that are actually a number of straight line or irregular cuts to provide the non-planar surface. One example of such an embossing element is the embossing element 63 shown in FIG. 4.

Although not wishing to be bound by theory, it is believed that rounding the transition regions 85 or any portion of the distal ends of the embossing elements can provide the resulting paper with embossments that are more blunt with fewer rough edges. Thus, the resulting paper may be provided with a smoother and/or softer look and feel.

It should be noted that with respect to any of the methods described herein, the number of plies is not critical and can be varied, as desired. Thus, it is within the realm of the present invention to utilize methods and equipment that provide a final web product having a single ply, two plies, three plies, four plies or any other number of plies suitable for the desired end use. In each case, it is understood that one of skill in the art would know to add or remove the equipment necessary to provide and/or combine the different number of plies. Further, it should be noted that the plies of a multi-ply web product need not be the same in make-up or other characteristics. Thus, the different plies can be made from different materials, such as from different fibers, different combinations of fibers, natural and synthetic fibers or any other combination of materials making up the base plies. Further, the resulting web 225 may include one or more plies of a cellulosic web and/or one or more plies of a web made from non-cellulose materials including polymeric materials, starch based materials and any other natural or synthetic materials suitable for forming fibrous webs. In addition, one or more of the plies may include a nonwoven web, a woven web, a scrim, a film a foil or any other generally planar sheet-like material. Further, one or more of the plies can be embossed with a pattern that is different that one or more of the other plies or can have no embossments at all.

As noted above, the apparatus 10 of the present invention may act on any deformable material. However, the device 10 is most typically used to emboss web-like structures or products that are generally planar and that have length and width dimensions that are significantly greater than the thickness of the web or product. Often, it is advantageous to use such an apparatus 10 on films, nonwoven materials, woven webs, foils, fibrous structures and the like. One suitable type of web for use with the apparatus 10 of the present invention 10 is a paper web. (As used herein, the term “paper web” refers to webs including at least some cellulosic fibers. However, it is contemplated that paper webs suitable for use with the apparatus 10 of the present invention can also include fibers including synthetic materials, natural fibers other than those including cellulose and/or man-made fibers including natural materials.)

In certain embodiments of the present invention, the method includes providing one or more plies of paper having an embossed wet burst strength and an unembossed wet burst strength. The paper web is embossed resulting in a web having a plurality of embossments with an average embossment height of at least about 650 μm. The paper web can have any desirable embossed and unenbossed wet burst strength. In certain embodiments, it may be desirable for the paper web to have an embossed wet burst strength of at least about 300 g. Further, it may be desirable for the finished product (embossed) wet burst strength to be greater than about 60%, greater than about 65%, greater than about 70%, greater that about 75%, greater than about 80% or greater 85% of the unembossed wet burst strength. In such embodiments, the ply or plies of paper produced to be the substrate of the deep-nested embossed paper product may be any type of fibrous structures described herein, such as, for example, the paper is a tissue-towel product. The unembossed wet burst strength of the incoming plies are measured using the Wet Burst Strength Test Method described below. When more than one plies of paper are embossed the wet burst strength is measured on a sample taken on samples of the individual plies placed together, face-to-face without glue, into the tester.

Although any known paper substrate may be used with the present invention, certain exemplary paper product substrates may be made according U.S. Pat. No. 4,191,609 issued Mar. 4, 1980 to Trokhan; U.S. Pat. No. 4,300,981 issued to Carstens on Nov. 17, 1981; U.S. Pat. No. 4,514,345 issued to Johnson et al. on Apr. 30, 1985; U.S. Pat. No. 4,528,239 issued to Trokhan on Jul. 9, 1985; U.S. Pat. No. 4,529,480 issued to Trokhan on Jul. 16, 1985; U.S. Pat. No. 4,637,859 issued to Trokhan on Jan. 20, 1987; U.S. Pat. No. 5,245,025 issued to Trokhan et al. on Sep. 14, 1993; U.S. Pat. No. 5,275,700 issued to Trokhan on Jan. 4, 1994; U.S. Pat. No. 5,328,565 issued to Rasch et al. on Jul. 12, 1994; U.S. Pat. No. 5,334,289 issued to Trokhan et al. on Aug. 2, 1994; U.S. Pat. No. 5,364,504 issued to Smurkowski et al. on Nov. 15, 1995; U.S. Pat. No. 5,527,428 issued to Trokhan et al. on Jun. 18, 1996; U.S. Pat. No. 5,556,509 issued to Trokhan et al. on Sep. 17, 1996; U.S. Pat. No. 5,628,876 issued to Ayers et al. on May 13, 1997; U.S. Pat. No. 5,629,052 issued to Trokhan et al. on May 13, 1997; U.S. Pat. No. 5,637,194 issued to Ampulski et al. on Jun. 10, 1997; U.S. Pat. No. 5,411,636 issued to Hermans et al. on May 2, 1995; U.S. Pat. No. 6,017,417 issued to Wendt et al. on Jan. 25, 2000; U.S. Pat. No. 5,746,887 issued to Wendt et al. on May 5, 1998; U.S. Pat. No. 5,672,248 issued to Wendt et al. on Sep. 30, 1997; and U.S. Patent Application 2004/0192136A1 published in the name of Guskey et al. on Sep. 30, 2004.

Paper substrates may be manufactured via wet-laid papermaking processes where the resulting web is through-air-dried or conventionally dried. Optionally, the substrate may be foreshortened by creping, by wet microcontraction or by any other means. Creping and/or wet microcontraction are disclosed in commonly assigned U.S. Pat. No. 6,048,938 issued to Neal et al. on Apr. 11, 2000; U.S. Pat. No. 5,942,085 issued to Neal et al. on Aug. 24, 1999; U.S. Pat. No. 5,865,950 issued to Vinson et al. on Feb. 2, 1999; U.S. Pat. No. 4,440,597 issued to Wells et al. on Apr. 3, 1984; U.S. Pat. No. 4,191,756 issued to Sawdai on May 4, 1980; and U.S. Pat. No. 6,187,138 issued to Neal et al. on Feb. 13, 2001.

Conventionally pressed tissue paper and methods for making such paper are, for example, as described in U.S. Pat. No. 6,547,928 issued to Barnholtz et al. on Apr. 15, 2003. One suitable tissue paper is pattern densified tissue paper which is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Processes for making pattern densified tissue webs are disclosed in U.S. Pat. No. 3,301,746 issued to Sanford and Sisson on Jan. 31, 1967; U.S. Pat. No. 3,473,576 issued to Amneus on Oct. 21, 1969; U.S. Pat. No. 3,573,164 issued to Friedberg, et al. on Mar. 30, 1971; U.S. Pat. No. 3,821,068 issued to Salvucci, Jr. et al. on May 21, 1974; U.S. Pat. No. 3,974,025 issued to Ayers on Aug. 10, 1976; U.S. Pat. No. 4,191,609 issued to on Mar. 4, 1980; U.S. Pat. No. 4,239,065 issued to Trokhan on Dec. 16, 1980 and U.S. Pat. No. 4,528,239 issued to Trokhan on Jul. 9, 1985 and U.S. Pat. No. 4,637,859 issued to Trokhan on Jan. 20, 1987.

Uncompacted, nonpattern-densified tissue paper structures are also suitable for use with the present invention and are described in U.S. Pat. No. 3,812,000 issued to Joseph L. Salvucci, Jr. and Peter N. Yiannos on May 21, 1974, and U.S. Pat. No. 4,208,459, issued to Henry E. Becker, Albert L. McConnell, and Richard Schutte on Jun. 17, 1980. Uncreped paper can also be subjected to the apparatus and method of the present invention. Suitable techniques for producing uncreped tissue are taught, for example, in U.S. Pat. No. 6,017,417 issued to Wendt et al. on Jan. 25, 2000; U.S. Pat. No. 5,746,887 issued to Wendt et al. on May 5, 1998; U.S. Pat. No. 5,672,248 issued to Wendt et al. on Sep. 30, 1997; U.S. Pat. No. 5,888,347 issued to Engel et al. on Mar. 30, 1999; U.S. Pat. No. 5,667,636 issued to Engel et al. on Sep. 16, 1997; U.S. Pat. No. 5,607,551 issued to Farrington et al. on Mar. 4, 1997 and U.S. Pat. No. 5,656,132 issued to Farrington et al. on Aug. 12, 1997.

Substrates suitable for use with the present invention may alternatively be manufactured via an air-laid making process. An example of one process for making such airlaid paper substrates is found in U.S. Patent Application 2004/0192136A1 filed in the name of Gusky et al. and published on Sep. 30, 2004.

The web may also or alternatively include fibers, films and/or foams that comprises a hydroxyl polymer and optionally a crosslinking system. Nonlimiting examples of suitable hydroxyl polymers include polyols, such as polyvinyl alcohol, polyvinyl alcohol derivatives, polyvinyl alcohol copolymers, starch, starch derivatives, chitosan, chitosan derivatives, cellulose derivatives such as cellulose ether and ester derivatives, gums, arabinans, galactans, proteins and various other polysaccharides and mixtures thereof. For example, the web may include a continuous and/or substantially continuous fiber comprising a starch hydroxyl polymer and a polyvinyl alcohol hydroxyl polymer produced by dry spinning and/or solvent spinning (both unlike wet spinning into a coagulating bath) a composition comprising the starch hydroxyl polymer and the polyvinyl alcohol hydroxyl polymer.

Representative examples of other substrates can be found in U.S. Pat. No. 4,629,643 issued to Curro et al. on Dec. 16, 1986; U.S. Pat. No. 4,609,518 issued to Curro et al. on Sep. 2, 1986; U.S. Pat. No. 4,603,069 issued to Haq et al. on Jul. 29 1986; U.S. Patent Publications 2004/0154768 A1 published to Trokhan et al. on Aug. 12, 2004; 2004/0154767 A1 published to Trokhan et al. on Aug. 12, 2004; 2003/0021952 A1 published to Zink et al. on Jan. 30, 2003; and 2003/0028165 A1 published to Curro et al. on Feb. 6, 2003.

Other optional equipment may be used and/or processes may be performed on the web during its manufacture or after it is manufactured, as desired. These processes can be performed before or after the embossing method of the present invention, as applicable. For example, in certain embodiments, it may be desirable to provide heat, moisture or steam to the web prior to the web being embossed. Exemplary suitable apparatuses and methods for providing steam to a web to be embossed are described in U.S. Pat. No. 4,207,143 issued to Glomb et al. on Jun. 10, 1980; U.S. Pat. No. 4,994,144 issued to Smith et al. on Feb. 19, 1991; U.S. Pat. No. 6,074,525 issued to Richards on Jun. 13, 2000 and U.S. Pat. No. 6,077,590 issued to Archer on Jun. 20, 2000. However, any suitable apparatus and/or method for providing heat, moisture or steam to the web may be used, including the use of steam bars, airfoils, sprayers, steam chambers or any combination thereof.

One example of an embossed web product is shown in FIG. 5. The embossed web product 225 comprises one or more plies, wherein at least one of the plies comprises a plurality of embossments 400. The ply or plies which are embossed are embossed such that the embossments exhibit an embossment height 410. The embossments can have any suitable embossment height. In certain embodiments, such as where the web is subjected to a deep-nested embossing process, the embossments may have an embossment height of at least about 650 μm, at least about 1000 μm, at least about 1250 μm, at least about 1450 μm, at least about 1550 μm, at least about 1800 μm, at least about 2000 μm, at least about 3000 μm, at least about 4000 μm, between about 650 μm and about 4000 μm or any individual number within this range. (The embossment height 410 of the embossed product 225 is measured by the Embossment Height Test method set forth below.) One advantage of the present invention is that it provides an improved method for producing embossments heights as set forth above. Further, because the embossing apparatus and method can be separated from other operations, the method of the present invention can help the web product 225 better maintain greater embossment heights. Thus, the embossing step may be more efficient than in other methods where the embossments may be subsequently reduced in height by downstream operations or may disadvantageously re-orient themselves with respect to each other in multi-ply webs.

The embossed web product of the present invention may be converted for sale or use into any desired form. For example, the web may be wound into rolls, folded, stacked, perforated and/or cut into individual sheets of any desired size.

### Test Methods

Embossment Height Test Method

Embossment height is measured using an Optical 3D Measuring System MikroCAD compact for paper measurement instrument (the “GFM MikroCAD optical profiler instrument”) and ODSCAD Version 4.0 software available from GFMesstechnik GmbH, Warthestraβe E21, D14513 Teltow, Berlin, Germany. The GFM MikroCAD optical profiler instrument includes a compact optical measuring sensor based on digital micro-mirror projection, consisting of the following components:
A) A DMD projector with 1024×768 direct digital controlled micro-mirrors.
B) CCD camera with high resolution (1300×1000 pixels).
C) Projection optics adapted to a measuring area of at least 27×22 mm.
D) Recording optics adapted to a measuring area of at least 27×22 mm; a table tripod based on a small hard stone plate; a cold-light source; a measuring, control, and evaluation computer; measuring, control, and evaluation software, and adjusting probes for lateral (X-Y) and vertical (Z) calibration.
E) Schott KL1500 LCD cold light source.
F) Table and tripod based on a small hard stone plate.
G) Measuring, control and evaluation computer.
H) Measuring, control and evaluation software ODSCAD 4.0.
I) Adjusting probes for lateral (x-y) and vertical (z) calibration.

The GFM MikroCAD optical profiler system measures the height of a sample using the digital micro-mirror pattern projection technique. The result of the analysis is a map of surface height (Z) versus X-Y displacement. The system should provide a field of view of 27×22 mm with a resolution of 21 μm. The height resolution is set to between 0.101 μm and 1.00 μm. The height range is 64,000 times the resolution. To measure a fibrous structure sample, the following steps are utilized:
1. Turn on the cold-light source. The settings on the cold-light source are set to provide a reading of at least 2,800 k on the display.
2. Turn on the computer, monitor, and printer, and open the software.
3. Select “Start Measurement” icon from the ODSCAD task bar and then click the “Live Image” button.
4. Obtain a fibrous structure sample that is larger than the equipment field of view and conditioned at a temperature of 73° F.±2° F. (about 23° C.+1° C.) and a relative humidity of 50%±2% for 2 hours. Place the sample under the projection head. Position the projection head to be normal to the sample surface.
5. Adjust the distance between the sample and the projection head for best focus in the following manner. Turn on the “Show Cross” button. A blue cross should appear on the screen. Click the “Pattern” button repeatedly to project one of the several focusing patterns to aid in achieving the best focus. Select a pattern with a cross hair such as the one with the square. Adjust the focus control until the cross hair is aligned with the blue “cross” on the screen.
6. Adjust image brightness by changing the aperture on the lens through the hole in the side of the projector head and/or altering the camera gains setting on the screen. When the illumination is optimum, the red circle at the bottom of the screen labeled “I.O.” will turn green.
7. Select technical surface/rough measurement type.
8. Click on the “Measure” button. When keeping the sample still in order to avoid blurring of the captured image.
9. To move the data into the analysis portion of the software, click on the clipboard/man icon.
10. Click on the icon “Draw Cutting Lines.” On the captured image, “draw” six cutting lines (randomly selected) that extend from the center of a positive embossment through the center of a negative embossment to the center of another positive embossment. Click on the icon “Show Sectional Line Diagram.” Make sure active line is set to line 1. Move the cross-hairs to the lowest point on the left side of the computer screen image and click the mouse. Then move the cross-hairs to the lowest point on the right side of the computer screen image on the current line and click the mouse. Click on the “Align” button by marked point's icon. Click the mouse on the lowest point on this line and then click the mouse on the highest point of the line. Click the “Vertical” distance icon. Record the distance measurement. Increase the active line to the next line, and repeat the previous steps until all six lines have been measured. Perform this task for four sheets equally spaced throughout the Finished Product Roll, and four finished product rolls for a total of 16 sheets or 96 recorded height values. Take the average of all recorded numbers and report in mm, or μm, as desired. This number is the embossment height.
   Wet Burst Strength Method

“Wet Burst Strength” as used herein is a measure of the ability of a fibrous structure and/or a paper product incorporating a fibrous structure to absorb energy, when wet and subjected to deformation normal to the plane of the fibrous structure and/or paper product. Wet burst strength may be measured using a Thwing-Albert Burst Tester Cat. No. 177 equipped with a 2000 g load cell commercially available from Thwing-Albert Instrument Company, Philadelphia, Pa.

For 1-ply and 2-ply products having a sheet length (MD) of approximately 11 inches (280 mm) remove two usable units from the roll. Carefully separate the usable units at the perforations and stack them on top of each other. Cut the usable units in half in the Machine Direction to make a sample stack of four usable units thick. For usable units smaller than 11 inches (280 mm) carefully remove two strips of three usable units from the roll. Stack the strips so that the perforations and edges are coincident. Carefully remove equal portions of each of the end usable units by cutting in the cross direction so that the total length of the center unit plus the remaining portions of the two end usable units is approximately 11 inches (280 mm). Cut the sample stack in half in the machine direction to make a sample stack four usable units thick.

The samples are next oven aged. Carefully attach a small paper clip or clamp at the center of one of the narrow edges. “Fan” the other end of the sample stack to separate the towels which allows circulation of air between them. Suspend each sample stack by a clamp in a 221° F.±2° F. (105° C.±1° C.) forced draft oven for five minutes±10 seconds. After the heating period, remove the sample stack from the oven and cool for a minimum of 3 minutes before testing. Take one sample strip, holding the sample by the narrow cross machine direction edges, dipping the center of the sample into a pan filled with about 25 mm of distilled water. Leave the sample in the water four (4) (±0.5) seconds. Remove and drain for three (3) (±0.5) seconds holding the sample so the water runs off in the cross machine direction. Proceed with the test immediately after the drain step. Place the wet sample on the lower ring of a sample holding device of the Burst Tester with the outer surface of the sample facing up so that the wet part of the sample completely covers the open surface of the sample holding ring. If wrinkles are present, discard the samples and repeat with a new sample. After the sample is properly in place on the lower sample holding ring, turn the switch that lowers the upper ring on the Burst Tester. The sample to be tested is now securely gripped in the sample holding unit. Start the burst test immediately at this point by pressing the start button on the Burst Tester. A plunger will begin to rise toward the wet surface of the sample. At the point when the sample tears or ruptures, report the maximum reading. The plunger will automatically reverse and return to its original starting position. Repeat this procedure on three (3) more samples for a total of four (4) tests, i.e., four (4) replicates. Report the results as an average of the four (4) replicates, to the nearest g.

All documents cited in the Detailed Description of the Invention are, in relevant part, incorporated by reference herein; the citation of any document is not to be construed as an admission that it is prior art with respect to the present invention. To the extent that any meaning or definition of the term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method for producing a multi-ply embossed product comprising the steps of:
a) providing two or more plies of material to a lamination apparatus, each ply having a lamination surface;
b) laminating one ply of the two or more plies of material to at least one other of the two or more plies of material to provide a laminated web having a first lamination pattern;
c) directing the laminated web to a separate embossing apparatus; and
d) embossing the laminated web in a second pattern to provide an embossed web, wherein the embossing step takes place after the laminated web is laminated.

2. The method of claim 1 wherein the first pattern is discontinuous or semi-continuous.

3. The method of claim 1 wherein an adhesive is applied to a surface of at least one of the two or more plies of material in the first lamination pattern and the first lamination pattern covers less than about 10% of the lamination surface of ply or plies to which it is applied.

4. The method of claim 1 wherein an adhesive is applied to a surface of at least one of the two or more plies of material in the first lamination pattern and the first lamination pattern covers less than about 5% of the lamination surface of ply or plies to which it is applied.

5. The method of claim 1 wherein embossing apparatus includes a first roll and a second roll provided adjacent each other and forming a nip therebetween, the first roll having a first surface and the second roll having a second surface, wherein the laminated web is disposed on at least a portion of the first surface or second surface of one of the first or second rolls prior to or after the laminated web passes through the nip.

6. The method of claim 5 wherein the laminated web is s-wrapped about the first and second rolls.

7. The method of claim 1 further including a step of printing on the laminated web prior to embossing the laminated web.

8. The method of claim 1 wherein the embossing apparatus includes a first embossing member and a second embossing member and wherein the first embossing member and the second embossing member have nesting embossing elements such that when the laminated web is embossed, it results in a laminated embossed web comprising a plurality of embossments having an average embossment height of at least about 650 μm.

9. The method of claim 8 where the resulting laminated embossed web has an average embossment height of at least about 1000 μm.

10. The method of claim 8 where the resulting laminated embossed web has an average embossment height of at least about 1250 μm.

11. The method of claim 8 where the resulting laminated embossed web has an average embossment height of at least about 1450 μm.

12. The method of claim 1, wherein at least one of the two or more plies of material comprise a paper web having an unembossed wet burst strength and the paper web after being embossed has a wet burst strength of greater than about 60% of the unembossed wet burst strength.

13. The method of claim 1, wherein at least one of the two or more plies of material comprise a paper web having an unembossed wet burst strength and the paper web after being embossed has a wet burst strength of greater than about 75% of the unembossed wet burst strength.

14. The method of claim 1, wherein the first embossing member and the second embossing member have nesting embossing elements and wherein the embossing elements engage each other to a depth of greater than about 1.5 mm.

15. The method of claim 1, wherein embossing apparatus has a first embossing member and a second embossing member and wherein the first embossing member and the second embossing member have nesting embossing elements that engage each other to a depth of greater than about 3.0 mm.

16. The method of claim 1 wherein at least one of the two or more plies of material includes at least some cellulosic fibers and the method further comprises one or more of the following steps: providing moisture, heat and/or steam to the laminated web prior to the laminated web being embossed.

17. The method of claim 1 wherein all of the at least two plies of material include at least some cellulosic fibers.

18. The method of claim 1 wherein at least one of the plies of the material is a through air dried paper web.

19. The method of claim 1 wherein all of the two or more plies of material are through air dried paper webs.

20. The method of claim 1 wherein the embossing step takes place at least about 0.25 seconds after the laminated web is provided.

21. The method of claim 1 wherein the embossing step takes place at least about 0.5 seconds after the laminated web is provided.

22. The method of claim 1 wherein the step of laminating one ply of the two or more plies of material to at least one other of the two or more plies of material to provide a laminated web having a first lamination pattern includes applying an adhesive to at least one ply of the two or more plies of material and the adhesive includes from about 2% to about 5% solids by weight.

23. The method of claim 1 wherein the step of laminating one ply of the two or more plies of material to at least one other of the two or more plies of material to provide a laminated web having a first lamination pattern includes applying an adhesive to at least one ply of the two or more plies of material and the adhesive includes greater than about 5% solids by weight.

24. The method of claim 1 wherein at least one of the two or more plies is creped.

25. The method of claim 1 wherein at least one of the two or more plies is uncreped.
